(19) United States
(12) Patent Application Publication
(10) Pub. No.: US 2026/0079917 A1
(43) Pub. Date: Mar. 19, 2026

(54) SYSTEM AND METHOD FOR QUERYING A DATABASE BY INTEGRATING ARTIFICIAL INTELLIGENCE WITH DATA STREAMING

(71) Applicant: Confluent, Inc., Mountain View, CA (US)

(72) Inventors: Pascal Vantrepote, Toronto (CA); John Byrne, Enniskillen (IE); Andrew Sellers, Monument, CO (US)

(21) Appl. No.: 19/316,673

(22) Filed: Sep. 2, 2025

Related U.S. Application Data
(60) Provisional application No. 63/695,087, filed on Sep. 16, 2024.

(51) Int. Cl. G06F 16/242; G06F 16/2455; G06F 16/34

(52) U.S. Cl. CPC G06F 16/242; G06F 16/2455; G06F 16/345

(57) ABSTRACT

Systems and methods for integrating generative artificial intelligence (AI) with real-time data streaming platforms in distributed computing environments are disclosed. A real-time streaming platform receives a natural language input from a client device, stores a corresponding text request in a topic, and generates a prompt using a processing engine. The prompt is provided to a generative AI system, which generates a structured query language (SQL) query. The SQL query is stored in the topic and executed on a cloud SQL database to obtain an SQL result. The SQL result is stored in the topic and a response based on the SQL result is transmitted to the client device. This approach leverages real-time data streaming, automated prompt generation, and AI-driven query construction to facilitate accurate and timely access to distributed data sources.

### CROSS-REFERENCE TO RELATED APPLICATION

This patent application claims the benefit of U.S. Provisional Patent Application No. 63/695,087, filed Sep. 16, 2024, entitled “SYSTEM AND METHOD FOR QUERYING A DATABASE BY INTEGRATING ARTIFICIAL INTELLIGENCE WITH DATA STREAMING”, which is incorporated by reference herein in its entirety.

### TECHNICAL FIELD

The subject matter disclosed herein generally relates to real-time data streaming in distributed computing environments. Specifically, the present disclosure addresses systems and methods that integrate generative artificial intelligence (AI) with real-time data streaming associated with a distributed stream-processing platform.

### BACKGROUND

Cloud computing systems have become increasingly popular for delivering computer-implemented resources to end-users. Service providers offer a variety of services tailored to the specific needs of different users, including the ability to stream content using various streaming protocols. One widely used streaming protocol is the Apache™ Kafka™ platform.

Apache™ Kafka™ is a distributed streaming platform that operates as a cluster of nodes, each functioning as a broker. Content producers send data to individual brokers within the cluster, and this data is typically organized into partitions by topic. When consumers wish to access specific content, they communicate with the appropriate broker to retrieve the desired data. However, in such distributed streaming environments, a significant technical challenge lies in enabling users to efficiently and accurately retrieve relevant information from large, continuously updating datasets. This complexity is further heightened by the necessity to construct precise queries that not only account for the structure and partitioning of data across multiple brokers, but also adapt to the dynamic, real-time nature of the data streams. These factors often render traditional query mechanisms inefficient or inadequate for timely data access.

### BRIEF DESCRIPTION OF THE DRAWINGS

Various ones of the appended drawings merely illustrate example examples of the present disclosure and should not be considered as limiting its scope.

FIG. 1 is a diagram illustrating an example network environment suitable for integrating artificial intelligence (AI) with a real-time streaming event platform, according to example embodiments.

FIG. 2 is a diagram illustrating data flow between components of the network environment that integrate AI for data retrieval using a voice input, according to example embodiments.

FIG. 3 is a diagram illustrating data flow between components of the network environment that integrate AI for data retrieval using a text input, according to example embodiments.

FIG. 4 is a diagram illustrating an alternative data flow between components of the network environment that integrates AI for data retrieval using a text input, according to example embodiments.

FIG. 5 is a diagram illustrating data flow between components of the network environment for training a prompt model, according to example embodiments.

FIG. 6 is a block diagram illustrating components of a machine, according to some examples, able to read instructions from a machine-storage medium and perform any one or more of the methodologies discussed herein.

### DETAILED DESCRIPTION

The description that follows describes systems, methods, techniques, instruction sequences, and computing machine program products that illustrate examples of the present subject matter. In the following description, for purposes of explanation, numerous specific details are set forth in order to provide an understanding of various examples of the present subject matter. It will be evident, however, to those skilled in the art, that examples of the present subject matter may be practiced without some or other of these specific details. Examples merely typify possible variations. Unless explicitly stated otherwise, structures (e.g., structural components) are optional and may be combined or subdivided, and operations (e.g., in a procedure, algorithm, or other function) may vary in sequence or be combined or subdivided.

In today's fast-paced world of data and artificial intelligence (AI), maintaining high-quality, real-time data is critical for enabling generative AI models to make informed decisions. The accuracy and freshness of the data directly influence the relevance and effectiveness of the AI model's outputs, making it essential that the data used is both reliable and up-to-date.

Example embodiments comprises a distributed, real-time streaming platform that seamlessly integrates data from multiple sources in real time and leverages a processing engine to transform and process the data instantly. In various examples, the distributed streaming platform can be Apache Kafka™ or Confluent™ and the processing engine can be Apache Flink™ or Confluent Flink™. Real-time data quality is critical for ensuring informed effective generative AI interactions (e.g., model training, tuning, or to enrich the context used in responses) that can be performed in real time. Thus, by having access to fresh, real-time data, an AI's ability to generate more relevant and accurate outputs is enhanced. This real-time capability can bridge the gap between raw data and intelligent AI interactions and enables faster, more informed decisions.

To address the technical challenges associated with efficiently retrieving relevant data in distributed, real-time streaming environments, example embodiments provide a robust technical solution that integrates generative AI with a distributed streaming platform. This integration is achieved through the use of microservices, which enable the platform to scale flexibly and efficiently in response to varying workloads. Microservices allow individual processing tasks, such as query generation, data retrieval, and result summarization, to be independently managed and optimized, ensuring high performance and responsiveness.

In operation, the generative AI component translates natural language queries into structured SQL statements, allowing users to interact with underlying databases without the need for manual query construction. These databases can be hosted within a client's virtual private cloud (VPC), which helps maintain data confidentiality and security. After executing the SQL queries, the platform receives the results and employs generative AI to summarize the data, providing concise and relevant responses to the requester in real time. This approach streamlines the data retrieval process and enhances the overall effectiveness of AI-driven interactions within distributed streaming environments.

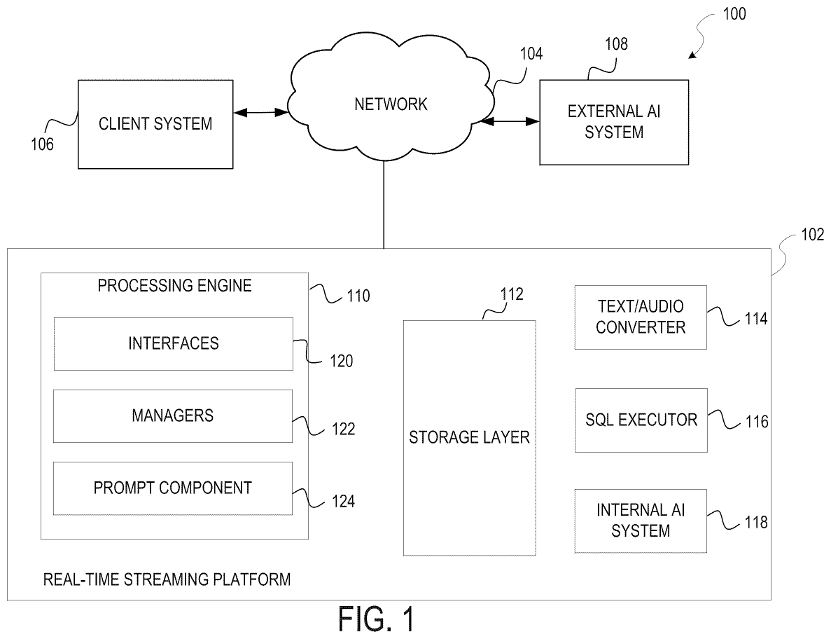

FIG. 1 is a diagram illustrating an example network environment 100 suitable for integrating artificial intelligence (AI) with a distributed, real-time streaming event platform, according to example embodiments. A real-time streaming platform 102 provides cloud-based functionality via a communication network 104 (e.g., the Internet, wireless network, cellular network, or a Wide Area Network (WAN)) to a client system 106. The real-time streaming platform 102 is configured to manage real-time data streaming. In one example, the real-time streaming platform 102 is Confluent Cloud™.

In various cases, the client system 106 is a system associated with a client or customer of the real-time streaming platform 102. The client system 106 comprises a plurality of client devices and storage devices. For example, the client devices may comprise, but is not limited to, a smartphone, a tablet, a laptop, multi-processor systems, microprocessor-based or programmable consumer electronics, a desktop computer, a server, or any other communication device that can access the real-time streaming platform 102. The client device can include an application that exchanges data, via the network 104, with the real-time streaming platform 102. For example, the application can be a local version of an application associated with the real-time streaming platform 102 that can provide data to and access data from one or more components at the real-time streaming platform 102. The data can, in some examples, be stored in cloud storage associated with the client system 106. In some embodiments, the cloud storage can be the client's virtual private cloud.

In example embodiments, the client system 106 interfaces with the real-time streaming platform 102 via a connection with the network 104. Depending on the form of the client devices of the client system 106, any of a variety of types of connections and networks 104 may be used. For example, the connection may be Code Division Multiple Access (CDMA) connection, a Global System for Mobile communications (GSM) connection, or another type of cellular connection. In another example, the connection to the network 104 is a Wireless Fidelity (e.g., Wi-Fi, IEEE 802.11x type) connection, a Worldwide Interoperability for Microwave Access (WiMAX) connection, or another type of wireless data connection. In such an example, the network 104 includes one or more wireless access points coupled to a local area network (LAN), a wide area network (WAN), the Internet, or another packet-switched data network. In yet another example, the connection to the network 104 is a wired connection (e.g., an Ethernet link) and the network 104 is a LAN, a WAN, the Internet, or another packet-switched data network. Accordingly, a variety of different configurations are expressly contemplated.

An external AI system 108 is a third-party AI system that performs generative AI operations or processing for the real-time streaming platform 102. For example, the external AI system 108 can comprise an LLM or generative artificial intelligence (AI) that generates SQL queries based on prompts generated by the real-time streaming platform 102. The LLM or generative AI is a trained model configured to generate text and perform natural language processing tasks. Generally, the LLM or generative AI learns relationships from a large data set during a training process and can then be used to generate text by taking an input and repeatedly predicting a next token or word, for example. While the LLM or generative AI can be within the external AI system 108, the LLM or generative AI can, in some implementations, be a part of the real-time streaming platform 102. In one example, the external AI system 108 is Gemini™ on VertexAI™.

Turning specifically to the real-time streaming platform 102, the real-time streaming platform 102 comprises a processing engine 110, a storage layer 112, a text/audio converter 114, a SQL executor 116, and an optional internal AI system 118. The real-time streaming platform 102 can comprise other components that are not germane to discussion of example implementations.

The processing engine 110 comprises a scalable stream processing framework for running stateful computations over unbounded and bounded data streams and enabling real-time data processing and analytics. Applications can be parallelized into a plurality of tasks that are distributed and concurrently executed in a cluster. In various examples, the processing engine 110 is Apache Flink® or Confluent Flink™. In one embodiment, the processing engine 110 comprises interfaces 120, managers 122, and a prompt component 124. The processing engine 110 can comprise other components that are not germane to discussion of example implementations. The interfaces 120 can comprise a DataStream API for bounded or unbounded streams of data and a DataSet API for bounded data sets. The interfaces 120 can also comprise a Table API, which is a SQL-like expression language for relational stream and batch processing that can be easily embedded in the DataStream and DataSet APIs. In some embodiments, the highest-level language supported by the processing engine 110 is SQL, which is semantically similar to the Table API and represents programs as SQL query expressions.

The managers 122 are responsible for coordinating the distributed execution of applications across the real-time streaming platform 102, ensuring that tasks are properly allocated and managed throughout the cluster. The managers 122 schedule tasks, detect and handle failures to maintain system reliability, and execute individual operations that comprise a dataflow. In addition, the managers 122 buffer data streams to manage fluctuations in data rates and facilitate the exchange of data streams between different components or nodes within the distributed system. These combined responsibilities enable efficient resource management, smooth data processing, and robust system performance in real-time streaming environments.

The prompt component 124 is responsible for generating prompts that are provided to the generative AI system (e.g., external AI system 108 or internal AI system 118) to facilitate the creation of SQL queries. Each prompt generated by the prompt component 124 is designed to describe all fields in all tables using plain language (e.g., plain English), enabling the AI system to fully understand the underlying data structure. The prompt should include detailed business descriptions for each table and field, as these descriptions are essential for the generative AI system to interpret the user's intent based on the request, provide necessary context, and guide the formation of an accurate query. Additionally, the prompt should provide an example of the expected SQL query, which provides the AI system a concrete reference for the desired output format. Finally, the prompt should specify the expected result (e.g., JSON result), clearly defining the content and structure of the final output. This comprehensive approach ensures that the generated SQL query is precise and aligned with business requirements.

In some embodiments, the prompt component 124 can tailor the prompt based on the specific SQL database being targeted. For instance, user location and/or database characteristics may be incorporated into the prompt to further refine the query. In some embodiments, tailoring the prompt based on the SQL database being targeted includes customizing the prompt to reflect the schema, structure, and specific requirements of the target database. For example, the prompt component 124 may retrieve metadata about the tables, fields, data types, and relationships present in the target database and incorporate this information into the prompt. The prompt may also be adjusted to account for the SQL dialect or syntax used by the database (e.g., MySQL, PostgreSQL, Microsoft SQL Server), ensuring that the generative AI system generates a query that is compatible with the database's expected format. Additionally, the prompt can include business logic, field descriptions, or data access constraints that are unique to the target database, thereby improving the accuracy and relevance of the generated SQL query.

In some embodiments, tailoring the prompt further includes incorporating user-specific contextual information, such as the user's current or specified location. The prompt component 124 may retrieve or receive location data (e.g., GPS coordinates, address, or zip code) associated with the client device and include this information in the prompt provided to the generative AI system. This enables the generative AI system to generate SQL queries that filter or aggregate data based on geographic proximity or other location-based criteria. For example, if a user requests information about providers within a five-mile radius, the prompt will specify the user's location and instruct the AI system to generate a query that applies the appropriate geospatial filtering logic for the target database. Once the prompt is constructed, it is transmitted to the AI system, which then generates the corresponding SQL statement or query.

Between the managers 122 and the prompt component 124, the processing engine 110 handles real-time processing of a natural language input, instantly translating a user's input/query into an actionable SQL statement. This not only ensures that quick, accurate results are obtained but also makes it easier to implement generative AI use cases by simplifying how natural language queries are transformed in real-time.

The processing engine 110 functions as a streaming compute layer to the storage layer 112. The storage layer 112 organizes data into topics, which are conceptually unbounded sequences of serialized events, with each event represented as an encoded key-value pair or message. Messages are sent to and retrieved from specific topics. In Kafka, topics are partitioned and replicated across brokers, with each broker representing a node within the Kafka cluster. This topic-based architecture enables seamless communication, supports parallel execution of tasks (such as microservices), and provides elasticity for scaling operations as needed.

The text/audio converter 114 is configured to convert audio files representing verbal queries received from a client device into text format using speech-to-text processing. The text/audio converter 114 also converts results generated by the real-time streaming platform 102 from text format into audio files using text-to-speech synthesis, allowing the output to be delivered to the client device in audio form. In some embodiments, the text/audio converter 114 may support multiple languages or dialects and may be located either within the real-time streaming platform 102 or as an external service communicatively coupled to the real-time streaming platform 102.

The SQL executor 116 is configured to trigger execution of SQL queries on a cloud SQL database. For example, the SQL executor 116 transmits the generated SQL query to the cloud SQL, which then runs the query against its stored data. After execution, the SQL executor 116 receives the resulting data set (SQL result) from the cloud SQL.

In some embodiments, the SQL executor 116 is further configured to detect and handle errors that may occur during the execution of SQL queries. Error handling may include monitoring for query syntax errors, connection failures, timeouts, or data access violations. Upon detecting an error, the SQL executor 116 may log the error, generate an error message or code, and/or attempt to retry the query or notify the appropriate microservice or client device of the failure. The SQL executor 116 may also provide diagnostic information to assist in troubleshooting, such as the specific query that failed, the nature of the error, and any relevant context from the execution environment. In some embodiments, error handling may further include query optimization or modification to address detected issues, thereby improving the reliability and robustness of the real-time streaming platform.

While the text/audio converter 114 and the SQL executor 116 are shown as part of the real-time streaming platform 102, the text/audio converter 114 and/or the SQL executor 116 can be located outside of the real-time streaming platform 102 and communicatively coupled thereto.

The internal AI system 118 is an AI system located within and under the control of the real-time streaming platform 102. In some embodiments, the internal AI system 118 is used instead of the external AI system 108 or vice-versa. In other embodiments, a determination is made as to which AI system to use. For example, the user/client can decide to only use the internal AI system 118 instead of providing information to the external AI system 108 of a third party. In another example, the real-time streaming platform 102 can determine, based on various factors (e.g., cost, load), which AI system should be used.

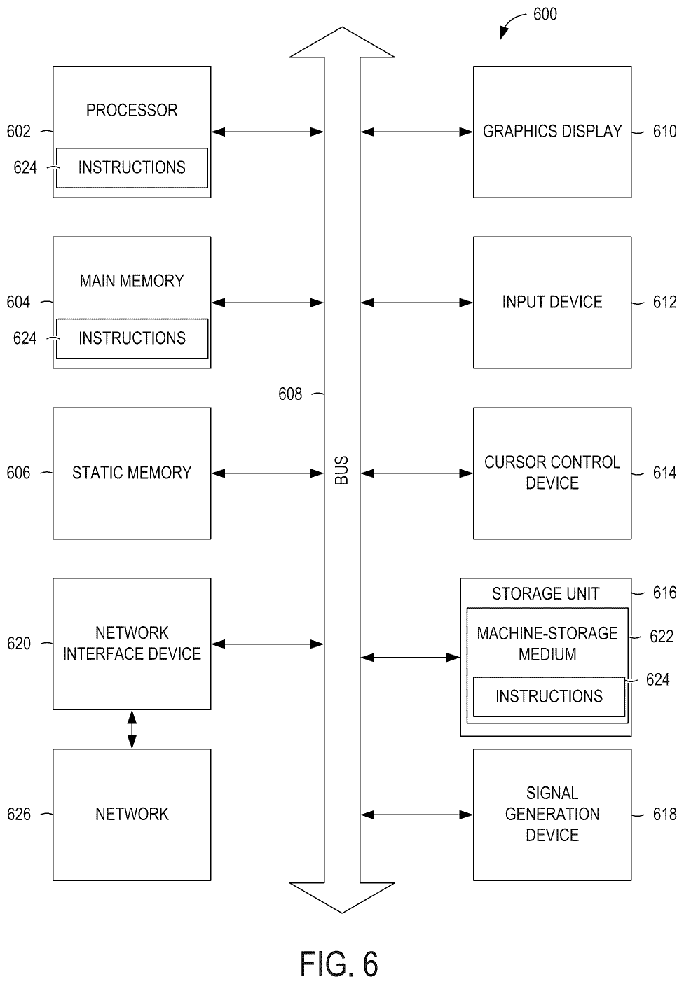

Any of the systems, engines, or devices (collectively referred to as “components”) shown in, or associated with, FIG. 1 may be, include, or otherwise be implemented in a special-purpose (e.g., specialized or otherwise non-generic) computer that can be modified (e.g., configured or programmed by software, such as one or more software components of an application, operating system, firmware, middleware, or other program) to perform one or more of the functions described herein for that system or machine. For example, a special-purpose computer system able to implement any one or more of the methodologies described herein is discussed below with respect to FIG. 6, and such a special-purpose computer is a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

Moreover, any two or more of the components illustrated in FIG. 1 may be combined, and the functions described herein for any single component may be subdivided among multiple components. Functionalities of one component may, in alternative examples, be embodied in a different component. Additionally, any number of client systems 106 and external AI systems 108 may be embodied within the network environment 100. While only a single real-time streaming platform 102 is shown, alternatively, more than one real-time streaming platform 102 can be included (e.g., localized to a particular region).

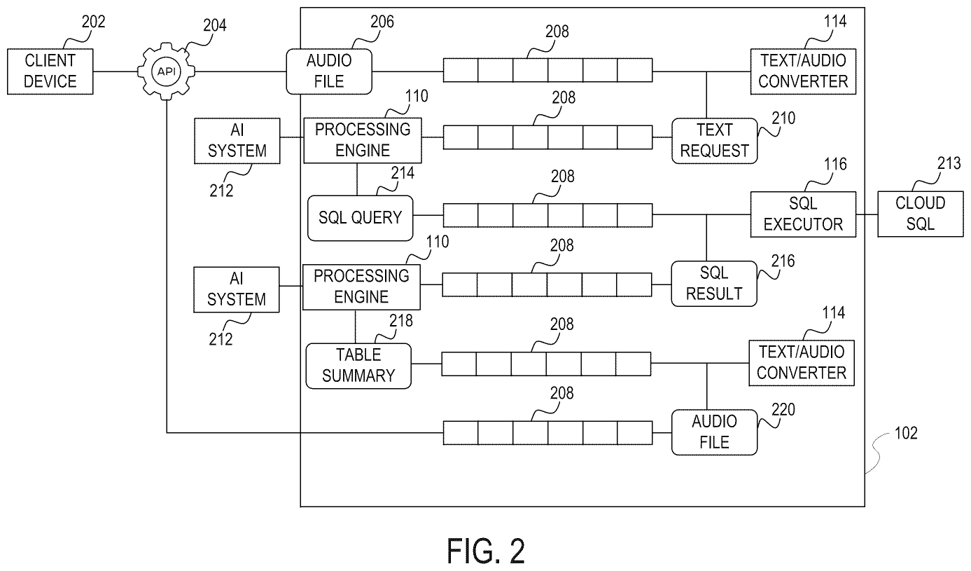

FIG. 2 is a diagram illustrating data flow between components of the network environment 100 that integrate AI for data retrieval using a voice input, according to example embodiments. In example embodiments, a user at a client device 202 of the client system 106 issues a verbal input (e.g., speech) that comprises a natural language query. As a use case example, the verbal input can be: “Show me providers within a 5-mile radius that have a higher than 75% success rate in treating lung cancer.” The verbal input is transmitted via an API 204 (e.g., REST API) and transformed into an audio file 206 in the real-time streaming platform 102. The audio file 206 then goes into a topic 208 in the storage layer 112. The text/audio converter 114 accesses the audio file 206 from the topic 208 and converts the audio file 206 into a text request 210. The text request 210 is then stored to the topic 208.

The processing engine 110 accesses the text request 210 from the topic 208 and the prompt component 124 of the processing engine 110 generates a prompt based on the text request 210. The prompt is tailored based on the SQL database that is being targeted. If the prompt is not precise enough, the SQL query may not work on the SQL database or return incorrect results. The prompt describes all fields in the tables, includes business descriptions for each field, provides an example of the expected SQL query, and specifies the expected response. The prompt can also include specific aspects associated with the natural language query. For example, in the use case, there is a geolocation aspect that is included in the prompt (e.g., within a 5-mile radius of a location of the user). Other aspects can include, for example, date, time, categories (e.g., a category of providers), types (e.g., using a specific treatment type), or any other aspect that helps narrow the query. Thus, the user can ask the real-time streaming platform 102 to identify the providers which have a high success rate within 5 miles of the user's location, and the real-time streaming platform 102 can target the right provider with the right query based on the target SQL database.

The prompt is then provided by the prompt component 124 to an AI system 212 (e.g., the external AI system 108 or the internal AI system 118). In some implementations, the processing engine 110 makes a direct call to the AI system 212, thus allowing real-time processing of natural language queries into SQL queries instantly (or as quickly as possible). The AI system 212 generates the SQL query 214 based on the prompt and returns the SQL query 214 to the prompt component 124 of the processing engine 110. The SQL query 214 is then stored to the topic 208.

The SQL executor 116 accesses the SQL query 214 from the topic 208 and triggers execution of the SQL query 214. For example, the SQL executor 116 transmits the SQL query 214 to a cloud SQL 213. The SQL query 214 triggers the cloud SQL 213, which runs the query against its stored data in the targeted databases. After execution, the SQL executor 116 then receives the SQL result 216 from the cloud SQL 213 and stored the SQL results back to the topic 208.

The processing engine 110 accesses the SQL result 216 from the topic 208 and pass the SQL result 216 to the AI system 212 with a prompt (e.g., summarization prompt) to summarize the SQL result 216 into a table. In some cases, the summarization prompt can provide an example of the expected table and specify the expected result. The AI system 212 returns a table summary 218 to the processing engine 110. The processing engine 110 then stores the table summary 218 to the topic 208.

In embodiments where the results are to be returned to the client device as speech, the text/audio converter 114 accesses the table summary 218 from the topic 208 and generates an audio file 220 by converting the text in the table summary 218 into audio. The audio file 220 is stored to the topic 208 and subsequently returned, via the API 204, to the client device 202 as a response. In the example use case, the audio file 220 can result in a verbal answer of: “The analysis focused on the success rate of treatment for lung cancer patients. The table specifically lists providers who have a success rate of greater than 75%. There is one provider listed in the table, Dr. Daniel Strand with MPI #1,3,013,210, who has a success rate of 82%. This means that based on the available data, 82% of the patients were treated successfully.”

In some embodiments, the results can be returned as text. In these embodiments, the SQL result 216 or the table summary 218 can be returned to the client device 202. In some embodiments, the real-time streaming platform 102 can generate and transmit a user interface (or transmit instructions to create the user interface) to the client device 202 that graphically displays the table summary 218 or provides a dashboard with data from the table summary 218. Further still, an API tool can be provided as a plug-in that allows a user to request a report on the data from the table summary 218 and the report can be generated in real time and returned.

By decomposing the generative AI workflow into smaller microservices and storing the output of each microservice on the topic 208, the real-time streaming platform 102 achieves greater control over scalability and responsiveness. Microservices are employed throughout the architecture to handle specific tasks, such as text and SQL processing or audio/text conversion, allowing each function to be independently scaled and optimized. For example, the real-time streaming platform 102 can support a higher volume of voice-to-text operations compared to text-to-voice, depending on demand. The use of topics facilitates seamless communication and parallel execution of these tasks. As a result, the real-time streaming platform 102 can efficiently scale up or down, optimize resource utilization, and effectively respond to varying client demands.

Additionally, because the real-time streaming platform 102 continuously receives new data, query results can be updated in real time to reflect the most current information. As new data is appended, the results dynamically change to incorporate these updates. In example embodiments, the real-time streaming platform 102 can replay the same SQL query at a predetermined later time or at regular intervals to obtain updated results based on newly received data. This replay functionality can be configured to run for a user-defined duration or for a default period set by the real-time streaming platform 102. For instance, in the above use case where new data increases a second provider's success rate to 76%, the real-time streaming platform 102 can identify and include this provider in the updated results.

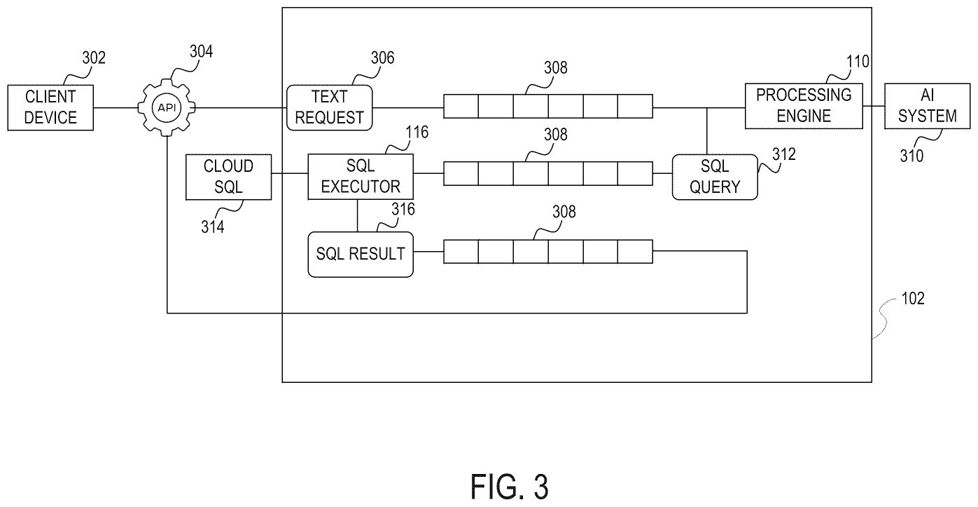

FIG. 3 is a diagram illustrating data flow between components of the network environment 100 that integrate AI for data retrieval using a text input, according to example implementations. In example implementations, a user at a client device 302 of the client system 106 issues a text input that comprises a natural language query. The text input is transmitted via an API 304 as a text request 306 to the real-time streaming platform 102. The text request 306 then goes into a topic 308 in the storage layer 112.

The processing engine 110 accesses the text request 306 from the topic 308 and the prompt component 124 of the processing engine 110 generates a prompt based on the text request 306. The prompt is tailored based on the SQL database that is being targeted and describes all fields in the tables, includes business descriptions for each field, provides an example of the expected SQL query, and specifies the expected response.

The prompt is then provided by the prompt component 124 to an AI system 310 (e.g., the external AI system 108 or the internal AI system 118). In example embodiments, the prompt component 124 makes a direct call to the AI system 310. This allows real-time processing of natural language queries into SQL queries instantly or in substantially real-time. The AI system 310 generates the SQL query 312 based on the prompt and returns the SQL query 312 to the prompt component 124 of the processing engine 110. The SQL query 312 is stored to the topic 308.

The SQL executor 116 accesses the SQL query 312 from the topic 308 and initiates execution of the SQL query 312. In one embodiment, the SQL executor 116 transmits the SQL query 312 to a cloud SQL 314, which runs the SQL query 312 against its targeted databases. After execution, the SQL executor 116 receives the SQL result 316 from the cloud SQL 314 and stores the SQL result 316 back to the topic 308. The SQL result 316 is then returned, via the API 304, to the client device 202 as a response from the real-time streaming platform 102.

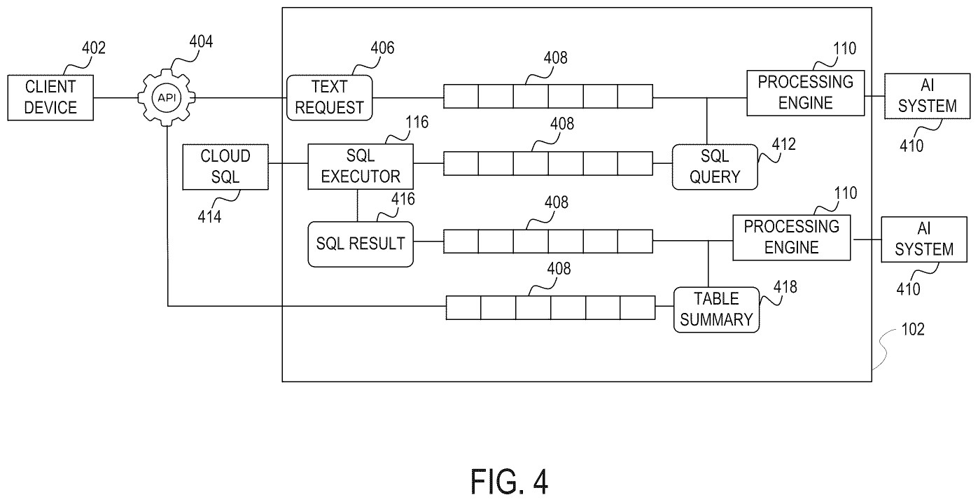

FIG. 4 is a diagram illustrating an alternative data flow between components of the network environment 100 that integrates AI for data retrieval using a text input, according to example implementations. A user at a client device 402 of the client system 106 issues a text input that comprises a natural language query. The text input is transmitted via an API 404 as a text request 406 to the real-time streaming platform 102. The text request 406 is then stored into a topic 408 in the storage layer 112.

The processing engine 110 accesses the text request 406 from the topic 408 and the prompt component 124 of the processing engine 110 generates a prompt based on the text request 406. The prompt is tailored based on the SQL database that is being targeted and describes all fields in the tables, includes business descriptions for each field, provides an example of the expected SQL query, and specifies the expected response.

The prompt is then provided by the prompt component 124 to an AI system 410 (e.g., the external AI system 108 or the internal AI system 118). In some cases, the prompt component 124 makes a direct call to the AI system 410. The AI system 410 generates a SQL query 412 based on the prompt and returns the SQL query 412 to the prompt component 124 of the processing engine 110. The SQL query 412 is then stored to the topic 408.

The SQL executor 116 accesses the SQL query 412 from the topic 408 and initiates its execution. For example, the SQL executor 116 transmits the SQL query 412 to a cloud SQL 414, which executes the query against its stored data in the targeted database. After execution, the SQL executor 116 receives the SQL result 416 from the cloud SQL 414 and stores the SQL result 416 back to the topic 408.

The processing engine 110 accesses the SQL result 416 from the topic 408 and pass the SQL result 416 to the AI system 410 with a prompt (e.g., summarization prompt) to summarize the SQL result 416 into a table. In some cases, the summarization prompt can provide an example of the expected table and specify the expected result. In response, the AI system 410 returns a table summary 418 to the processing engine 110, which stores the table summary 418 to the topic 408. The table summary 418 is subsequently returned, via the API 404, to the client device 402 by a component of the real-time streaming platform 102. In some cases, the table summary 418 can be converted to speech (similar to the operations discussed in connection to FIG. 2) prior to returning the result to the client device 402.

While the example embodiments of FIG. 2 and FIG. 4 describe generating a table summary from the SQL result, alternative embodiments may generate other types of summaries or reports based on the SQL result. The specific type of output generated is determined by the prompt provided to the AI system along with the SQL result.

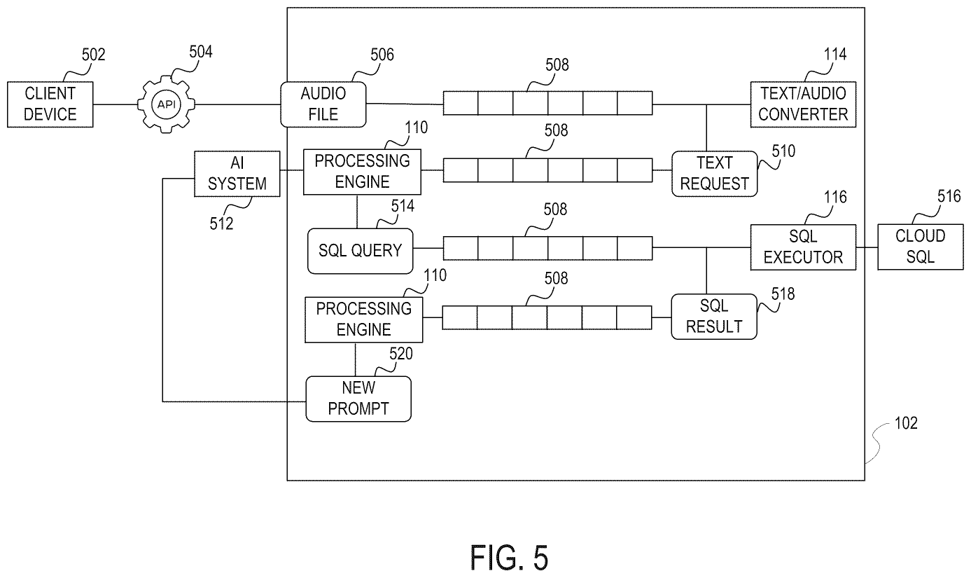

FIG. 5 is a diagram illustrating data flow between components of the network environment for training a prompt model of the prompt component 124, according to example embodiments. The prompt model within the prompt component 124 is responsible for generating and refining the prompts provided to the generative AI system. The prompt model may be implemented using rules-based logic, heuristics, or machine learning algorithms trained on historical data, including prior user requests, generated prompts, SQL queries, and query results. Training of the prompt model can be performed continuously and automatically within the real-time streaming platform 102, leveraging replayed events and A/B testing to compare the effectiveness of different prompt versions. Feedback from query outcomes, user interactions, or automated evaluation metrics can be used to further optimize the prompt model, ensuring that it adapts to evolving data structures and business requirements. Multiple versions of the prompt model may be maintained and evaluated in parallel, with the most effective version deployed for production use.

In example implementations, a user at a client device 502 of the client system 106 can issue a verbal input (e.g., speech) that comprises a natural language query. The verbal input is transmitted via an API 504 and transformed into an audio file 506 in the real-time streaming platform 102. The audio file 506 then goes into a topic 508 in the storage layer 112. The text/audio converter 114 accesses the audio file 506 from the topic 508 and converts the audio file 506 to a text request 510. The text request 510 is then stored to the topic 208.

In an alternative embodiment that does not use speech, the user at the client device 502 of the client system 106 issues a text input that comprises a natural language query. The text input is transmitted via the API 504 as the text request 510 to the real-time streaming platform 102. The text request 510 then is stored into the topic 508 in the storage layer 112.

The processing engine 110 accesses the text request 510 from the topic 508 and the prompt component 124 of the processing engine 110 generates a prompt based on the text request 510. The prompt is tailored based on the SQL database that is being targeted and can describe all fields in the tables, includes business descriptions for each field, provides an example of the expected SQL query, and specifies the expected response. A geolocation aspect can also be included in the prompt.

The prompt is then provided by the prompt component 124 to an AI system 512 (e.g., the external AI system 108 or the internal AI system 118). In some cases, the prompt component 124 makes a direct call to the AI system 512. The AI system 512 generates the SQL query 514 based on the prompt and returns the SQL query 514 to the prompt component 124 of the processing engine 110. The SQL query 514 is stored to the topic 508.

The SQL executor 116 accesses the SQL query 514 from the topic 508 and triggers execution of the SQL query 514. For example, the SQL executor 116 transmits the SQL query 514 to a cloud SQL 516, which triggers the cloud SQL 516 to run the SQL query 514 against its stored data. The SQL executor 116 then receives a SQL result 518 from the cloud SQL 516 and stores the SQL result 518 to the topic 508.

The processing engine 110 accesses the SQL result 518 from the topic and, using the prompt component 124 of the processing engine 110, generates a new prompt 520 based on the SQL result 518. Specifically, the prompt component 124 summarizes the SQL result 518 and formulates a new prompt 520, which may include a summarization prompt that instructs the AI system 512 to perform the summarization. The AI system 512 then generates different outcomes depending on the data being summarized.

Once the new prompt 520 is created, it is provided by the prompt component 124 to the AI system 512, which uses it to generate a new SQL query. This new SQL query is returned to the prompt component 124 and stored in the topic 508. The SQL executor 116 accesses the new SQL query from the topic 508, triggers its execution, and receives a new SQL result from the cloud SQL 516, which is then stored back to the topic 508.

This iterative process enables continuous training and refinement of the prompt model within the prompt component 124. With each new prompt, the prompt component 124 can identify, or instruct the AI system 512 to identify, differences between previous SQL results. Based on these differences, the prompt component 124 generates subsequent prompts, thereby improving the accuracy and relevance of the prompts used to generate SQL queries. By testing different prompts, the prompt model within the prompt component 124 can be continuously trained and improved. In particular, this prompt training process enhances the generation of business descriptions and the way fields are described within the prompts. As the quality of the prompts improves, the processing engine 110 is able to obtain more accurate and effective SQL queries that can be executed against the SQL databases.

One advantage of the real-time streaming platform 102 is that it can replay events and thus, can perform A/B testing of the prompts efficiently. Thus, the prompts can be tested with a plurality of different events, and different prompts can be replayed with similar events by resetting an offset to a desired position. The offset comprises a pointer to an event that the replay will restart from. Different versions of the prompt and their results can be compared to identify which ones perform better. These results and comparisons can be used (as training data) to retrain the prompt model. Through this continuous testing, training, and improvement process, the real-time streaming platform 102 ensures that the prompts generate SQL queries that are both accurate and relevant to the real-time context.

FIG. 6 illustrates components of a machine 600, according to some example embodiments, that is able to read instructions from a machine-storage medium (e.g., a machine-storage device, a non-transitory machine-storage medium, a computer-storage medium, or any suitable combination thereof) and perform any one or more of the methodologies discussed herein. Specifically, FIG. 6 shows a diagrammatic representation of the machine 600 in the example form of a computer device (e.g., a computer) and within which instructions 624 (e.g., software, a program, an application, an applet, an app, or other executable code) for causing the machine 600 to perform any one or more of the methodologies discussed herein may be executed, in whole or in part.

For example, the instructions 624 may cause the machine 600 to execute some or all of the diagrams of FIG. 2-FIG. 5. In one embodiment, the instructions 624 can transform the machine 600 into a particular machine (e.g., specially configured machine) programmed to carry out the described and illustrated functions in the manner described.

In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624 (sequentially or otherwise) that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The processor 602 may contain microcircuits that are configurable, temporarily or permanently, by some or all of the instructions 624 such that the processor 602 is configurable to perform any one or more of the methodologies described herein, in whole or in part. For example, a set of one or more microcircuits of the processor 602 may be configurable to execute one or more components described herein.

The machine 600 may further include a graphics display 610 (e.g., a plasma display panel (PDP), a light emitting diode (LED) display, a liquid crystal display (LCD), a projector, or a cathode ray tube (CRT), or any other display capable of displaying graphics or video). The machine 600 may also include an input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a sound card, an amplifier, a speaker, a headphone jack, or any suitable combination thereof), and a network interface device 620.

The storage unit 616 includes a machine-storage medium 622 (e.g., a tangible machine-storage medium) on which is stored the instructions 624 (e.g., software) embodying any one or more of the methodologies or functions described herein. The instructions 624 may also reside, completely or at least partially, within the main memory 604, within the processor 602 (e.g., within the processor's cache memory), or both, before or during execution thereof by the machine 600. Accordingly, the main memory 604 and the processor 602 may be considered as machine-storage media (e.g., tangible and non-transitory machine-storage media). The instructions 624 may be transmitted or received over a network 626 via the network interface device 620.

In some example embodiments, the machine 600 may be a portable computing device and have one or more additional input components (e.g., sensors or gauges). Examples of such input components include an image input component (e.g., one or more cameras), an audio input component (e.g., a microphone), a direction input component (e.g., a compass), a location input component (e.g., a global positioning system (GPS) receiver), an orientation component (e.g., a gyroscope), a motion detection component (e.g., one or more accelerometers), an altitude detection component (e.g., an altimeter), and a gas detection component (e.g., a gas sensor). Inputs harvested by any one or more of these input components may be accessible and available for use by any of the components described herein.

The various memories (e.g., 604, 606, and/or memory of the processor(s) 602) and/or storage unit 616 may store one or more sets of instructions and data structures (e.g., software) 624 embodying or utilized by any one or more of the methodologies or functions described herein. These instructions, when executed by processor(s) 602 cause various operations to implement the disclosed implementations.

As used herein, the terms “machine-storage medium,” “device-storage medium,” “computer-storage medium” (referred to collectively as “machine-storage medium 622”) mean the same thing and may be used interchangeably in this disclosure. The terms refer to a single or multiple storage devices and/or media (e.g., a centralized or distributed database, and/or associated caches and servers) that store executable instructions and/or data, as well as cloud-based storage systems or storage networks that include multiple storage apparatus or devices. The terms shall accordingly be taken to include, but not be limited to, solid-state memories, and optical and magnetic media, including memory internal or external to processors. Specific examples of machine-storage media, computer-storage media, and/or device-storage media 622 include non-volatile memory, including by way of example semiconductor memory devices, for example, erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage medium or media, computer-storage medium or media, and device-storage medium or media 622 specifically exclude carrier waves, modulated data signals, and other such media, at least some of which are covered under the term “signal medium” discussed below. In this context, the machine-storage medium is non-transitory.

The term “signal medium” or “transmission medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and signal media. Thus, the terms include both storage devices/media and carrier waves/modulated data signals.

The instructions 624 may further be transmitted or received over a communications network 626 using a transmission medium via the network interface device 620 and utilizing any one of a number of well-known transfer protocols (e.g., HTTP). Examples of communication networks 626 include a local area network (LAN), a wide area network (WAN), the Internet, mobile telephone networks, plain old telephone service (POTS) networks, and wireless data networks (e.g., Wi-Fi, LTE, and WiMAX networks). The term “transmission medium” shall be taken to include any intangible medium that is capable of storing, encoding, or carrying instructions 624 for execution by the machine 600, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components.

A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

In some embodiments, a hardware component may be implemented mechanically, electronically, or any suitable combination thereof. For example, a hardware component may include dedicated circuitry or logic that is permanently configured to perform certain operations. For example, a hardware component may be a special-purpose processor, such as a field programmable gate array (FPGA) or an ASIC. A hardware component may also include programmable logic or circuitry that is temporarily configured by software to perform certain operations. For example, a hardware component may include software encompassed within a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where the hardware component comprises a general-purpose processor configured by software to become a special-purpose processor, the general-purpose processor may be configured as respectively different special-purpose processors (e.g., comprising different hardware components) at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors.

Similarly, the methods described herein may be at least partially processor-implemented, a processor being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example implementations, the one or more processors or processor-implemented components may be located in a single geographic location (e.g., within a home environment, an office environment, or a server farm). In other example implementations, the one or more processors or processor-implemented components may be distributed across a number of geographic locations.

### EXAMPLES

Example 1 is a method for integrating generative AI with a real-time streaming platform to enable efficient and accurate data retrieval. The method comprises receiving, by a real-time streaming platform, a natural language input from a client device, the natural language input indicating a query to be performed on a SQL database; storing a text request corresponding to the natural language input in a topic of a storage layer, each topic comprising an unbounded sequence of serialized events; generating, by a processing engine of the real-time streaming platform, a prompt based on the text request, the prompt being used to prompt a generative artificial intelligence (AI) system to generate a SQL query; transmitting, by the processing engine, the prompt to the generative AI system; receiving, by the processing engine, an SQL query generated by the generative AI system based on the prompt; storing the SQL query to the topic in the storage layer; triggering, by an SQL executor of the real-time streaming platform, execution of the SQL query on a cloud SQL to obtain an SQL result; storing the SQL result in the topic of the storage layer; and transmitting, by the real-time streaming platform, a response to the client device based on the SQL result.

In example 2, the subject matter of example 1 can optionally include generating, by the generative AI system, a summary of the SQL result prior to transmitting the response to the client device, the response being based on the summary of the SQL result.

In example 3, the subject matter of any of examples 1-2 can optionally include storing the summary of the SQL result in the topic; and converting the summary of the SQL result into an audio file, wherein the response comprises the audio file of the summary of the SQL result.

In example 4, the subject matter of any of examples 1-3 can optionally include converting the response from text to audio prior to transmitting the response to the client device.

In example 5, the subject matter of any of examples 1-4 can optionally include wherein the natural language input comprises a verbal input, the method further comprising storing the verbal input as an audio file in the topic; and converting, by a text/audio converter, the audio file into the text request.

In example 6, the subject matter of any of examples 1-5 can optionally include wherein the natural language input comprises the text request.

In example 7, the subject matter of any of examples 1-6 can optionally include wherein the generative AI system comprises an external AI system; and the transmitting of the prompt to the generative AI system comprises making a direct call by the processing engine to the generative AI system.

In example 8, the subject matter of any of examples 1-7 can optionally include wherein the prompt describes fields in tables, includes business descriptions for each field, provides an example of an expected SQL query, and specifies an expected result.

In example 9, the subject matter of any of examples 1-8 can optionally include wherein generating the prompt comprises tailoring the prompt based on a location associated with the client device.

In example 10, the subject matter of any of examples 1-9 can optionally include wherein generating the prompt comprises tailoring the prompt based on the SQL database being targeted.

In example 11, the subject matter of any of examples 1-10 can optionally include performing A/B testing of different prompts by replaying events in the real-time streaming platform to improve accuracy and relevance of SQL queries generated by the generative AI system.

In example 12, the subject matter of any of examples 1-11 can optionally include replaying, by the real-time streaming platform, a previously executed SQL query to obtain updated SQL results based on newly received data, wherein the replaying is performed at a predetermined later time or at a regular interval.

In example 13, the subject matter of any of examples 1-12 can optionally include wherein each of the receiving, storing, generating, triggering, and transmitting is a microservice.

In example 14, the subject matter of any of examples 1-13 can optionally include wherein transmitting the response comprises generating and transmitting a user interface or dashboard that displays the SQL result or a summary of the SQL result.

In example 15, the subject matter of any of examples 1-14 can optionally include continuously training a prompt model within a prompt component of the processing engine based in part on replayed events to improve prompt accuracy and relevance.

Example 16 is a system for integrating generative AI with a real-time streaming platform to enable efficient and accurate data retrieval. The system comprises one or more processors and a memory storing instructions that, when executed by the one or more processors, cause the one or more processors to perform the operations comprising receiving a natural language input from a client device, the natural language input indicating a query to be performed on a SQL database; storing a text request corresponding to the natural language input in a topic of a storage layer, each topic comprising an unbounded sequence of serialized events; generating a prompt based on the text request, the prompt being used to prompt a generative artificial intelligence (AI) system to generate a SQL query; transmitting the prompt to the generative AI system; receiving an SQL query generated by the generative AI system based on the prompt; storing the SQL query to the topic in the storage layer; triggering execution of the SQL query on a cloud SQL to obtain an SQL result; storing the SQL result in the topic of the storage layer; and transmitting a response to the client device based on the SQL result.

In example 17, the subject matter of example 16 can optionally include wherein the operations further comprise performing A/B testing of different prompts by replaying events to improve accuracy and relevance of SQL queries generated by the generative AI system.

In example 18, the subject matter of any of examples 16-17 can optionally include wherein the operations further comprise replaying a previously executed SQL query to obtain updated SQL results based on newly received data, wherein the replaying is performed at a predetermined later time or at a regular interval.

In example 19, the subject matter of any of examples 16-18 can optionally include wherein the operations further comprise continuously training a prompt model within a prompt component of a processing engine based in part on replayed events to improve prompt accuracy and relevance.

Example 20 is a computer-storage medium comprising instructions which, when executed by one or more processors of a machine, cause the machine to perform operations comprising receiving a natural language input from a client device, the natural language input indicating a query to be performed on a SQL database; storing a text request corresponding to the natural language input in a topic of a storage layer, each topic comprising an unbounded sequence of serialized events; generating a prompt based on the text request, the prompt being used to prompt a generative artificial intelligence (AI) system to generate a SQL query; transmitting the prompt to the generative AI system; receiving an SQL query generated by the generative AI system based on the prompt; storing the SQL query to the topic in the storage layer; triggering execution of the SQL query on a cloud SQL to obtain an SQL result; storing the SQL result in the topic of the storage layer; and transmitting a response to the client device based on the SQL result.

Some portions of this specification may be presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

Although an overview of the present subject matter has been described with reference to specific examples, various modifications and changes may be made to these examples without departing from the broader scope of examples of the present invention. For instance, various examples or features thereof may be mixed and matched or made optional by a person of ordinary skill in the art. Such examples of the present subject matter may be referred to herein, individually or collectively, by the term “invention” merely for convenience and without intending to voluntarily limit the scope of this application to any single invention or present concept if more than one is, in fact, disclosed.

The examples illustrated herein are believed to be described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various examples of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of examples of the present invention as represented by the appended claims. The specification and drawings are, accordingly, to be regarded in an illustrative rather than a restrictive sense.

What is claimed is:

1. A method comprising:
receiving, by a real-time streaming platform, a natural language input from a client device, the natural language input indicating a query to be performed on a SQL database;
storing a text request corresponding to the natural language input in a topic of a storage layer, each topic comprising an unbounded sequence of serialized events;
generating, by a processing engine of the real-time streaming platform, a prompt based on the text request, the prompt being used to prompt a generative artificial intelligence (AI) system to generate a SQL query;
transmitting, by the processing engine, the prompt to the generative AI system;
receiving, by the processing engine, an SQL query generated by the generative AI system based on the prompt;
storing the SQL query to the topic in the storage layer;
triggering, by an SQL executor of the real-time streaming platform, execution of the SQL query on a cloud SQL to obtain an SQL result;
storing the SQL result in the topic of the storage layer; and
transmitting, by the real-time streaming platform, a response to the client device based on the SQL result.

2. The method of claim 1, further comprising:
generating, by the generative AI system, a summary of the SQL result prior to transmitting the response to the client device, the response being based on the summary of the SQL result.

3. The method of claim 2, further comprising:
storing the summary of the SQL result in the topic; and
converting the summary of the SQL result into an audio file, wherein the response comprises the audio file of the summary of the SQL result.

4. The method of claim 1, further comprising:
converting the response from text to audio prior to transmitting the response to the client device.

5. The method of claim 1, wherein the natural language input comprises a verbal input, the method further comprising:
storing the verbal input as an audio file in the topic; and
converting, by a text/audio converter, the audio file into the text request.

6. The method of claim 1, wherein the natural language input comprises the text request.

7. The method of claim 1, wherein:
the generative AI system comprises an external AI system; and
the transmitting of the prompt to the generative AI system comprises making a direct call by the processing engine to the generative AI system.

8. The method of claim 1, wherein the prompt describes fields in tables, includes business descriptions for each field, provides an example of an expected SQL query, and specifies an expected result.

9. The method of claim 1, wherein generating the prompt comprises tailoring the prompt based on a location associated with the client device.

10. The method of claim 1, wherein generating the prompt comprises tailoring the prompt based on the SQL database being targeted.

11. The method of claim 1, further comprising:
performing A/B testing of different prompts by replaying events in the real-time streaming platform to improve accuracy and relevance of SQL queries generated by the generative AI system.

12. The method of claim 1, further comprising:
replaying, by the real-time streaming platform, a previously executed SQL query to obtain updated SQL results based on newly received data, wherein the replaying is performed at a predetermined later time or at a regular interval.

13. The method of claim 1, wherein each of the receiving, storing, generating, triggering, and transmitting is a microservice.

14. The method of claim 1, wherein transmitting the response comprises generating and transmitting a user interface or dashboard that displays the SQL result or a summary of the SQL result.

15. The method of claim 1, further comprising:
continuously training a prompt model within a prompt component of the processing engine based in part on replayed events to improve prompt accuracy and relevance.

16. A system comprising:
one or more hardware processors; and
a memory storing instructions that, when executed by the one or more hardware processors, cause the one or more hardware processors to perform operations comprising:
receiving a natural language input from a client device, the natural language input indicating a query to be performed on a SQL database;
storing a text request corresponding to the natural language input in a topic of a storage layer, each topic comprising an unbounded sequence of serialized events;
generating a prompt based on the text request, the prompt being used to prompt a generative artificial intelligence (AI) system to generate a SQL query;
transmitting the prompt to the generative AI system;
receiving an SQL query generated by the generative AI system based on the prompt;
storing the SQL query to the topic in the storage layer;
triggering execution of the SQL query on a cloud SQL to obtain an SQL result;
storing the SQL result in the topic of the storage layer; and
transmitting a response to the client device based on the SQL result.

17. The system of claim 16, wherein the operations further comprise:
performing A/B testing of different prompts by replaying events to improve accuracy and relevance of SQL queries generated by the generative AI system.

18. The system of claim 16, wherein the operations further comprise:
replaying a previously executed SQL query to obtain updated SQL results based on newly received data, wherein the replaying is performed at a predetermined later time or at a regular interval.

19. The system of claim 16, wherein the operations further comprise:
continuously training a prompt model within a prompt component of a processing engine based in part on replayed events to improve prompt accuracy and relevance.

20. A machine-storage medium comprising instructions which, when executed by one or more processors of a machine, cause the machine to perform operations comprising:
receiving a natural language input from a client device, the natural language input indicating a query to be performed on a SQL database;
storing a text request corresponding to the natural language input in a topic of a storage layer, each topic comprising an unbounded sequence of serialized events;
generating a prompt based on the text request, the prompt being used to prompt a generative artificial intelligence (AI) system to generate a SQL query;
transmitting the prompt to the generative AI system;
receiving an SQL query generated by the generative AI system based on the prompt;
storing the SQL query to the topic in the storage layer;
triggering execution of the SQL query on a cloud SQL to obtain an SQL result;
storing the SQL result in the topic of the storage layer; and
transmitting a response to the client device based on the SQL result.
